(19) United States
(12) Patent Application Publication
(10) Pub. No.: US 2007/0263524 A1
(43) Pub. Date: Nov. 15, 2007

(54) Optical Media Formats And Methods of Making Same

(75) Inventors: Robert F. Thompson, Boca Raton, FL (US); Arthur R. Leblanc III, Kennebunk, ME (US); Edward P. Lindholm, Brookline, MA (US); Louis Cincotta, Andover, MA (US); Joseph Paulus, Portland, ME (US)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Flexplay Technologies, Inc., Atlanta, GA (US)

(21) Appl. No.: 11/467,685

(22) Filed: Aug. 28, 2006

Related U.S. Application Data
(60) Provisional application No. 60/711,616, filed on Aug. 26, 2005.

(51) Int. Cl. G11B 7/24

(52) U.S. Cl. 369/275.1

(57) ABSTRACT

Apparatuses, products, and devices consistent with the invention include optically readable media with at least one substrate, at least one encoded information region and/or region for receiving and/or recording encoded information, and at least one mechanism, chemical, agent, and/or process for limiting the time period that at least a portion of the at least one encoded information region and/or region for receiving and/or recording encoded information can be read and/or accessed by an optical beam and/or reader capable of reading the encoded information.

### RELATED APPLICATIONS

The present application is related to and claims the benefit of U.S. Provisional Application Ser. No. 60/711,616 filed Aug. 26, 2005 and is herein incorporated by reference in its entirety.

### BACKGROUND

### Field of the Invention

The present invention relates generally to optically readable media. More specifically, apparatuses, products and devices consistent with the invention are disclosed that include numerous configurations for encoding information on at least one substrate and/or data layer with at least one mechanism, chemical, agent, and/or process for limiting the time period that at least a portion of the encoded information can be read and/or accessed by an optical beam and/or reader capable of reading information encoded thereon.

### SUMMARY OF THE INVENTION

A dual format optically readable medium is disclosed. A first substrate includes data encoded information that is optically readable by an optical beam of a pre-selected wavelength. The first substrate is conjoined with a second substrate that includes data encoded information readable by an optical beam of a pre-selected wavelength. The two substrates are configured so as to allow the reading of the data encoded information stored on each substrate. At least one of the substrates includes a read inhibiting material that prohibits reading of the data encoded information on the first substrate, second substrate, or both substrates after a predetermined period of time. The format of the data encoded information is selected to be readable by an optical beam and may be selected from the formats of, for example, Compact Disc, CD-ROM, CD-WORM, CD-Interactive, DVI, CD-Erasable Magneto Optic, Optical Digital Data Disc, ODD, Video Disk, Interactive Video Disc, Blu-ray, High Definition-DVD, Digital Versatile Disc, DVD-R, DVD-Video, DVD-RAM, DVD-Audio, DVD-RAM, DVD-RW, DVD+RW, DVD+R, DVD-Video, Super Audio CD, Holographic Versatile Disk, CD-R, CD-RW, CD-Video, Enhanced Versatile Disc, Digital Versatile Disc Recordable, Digital Multilayer Disc, and Blu-ray recordable. The present disclosure also discloses novel dual format combinations that do not include a read inhibiting material and/or mechanism. Also disclosed are optical media capable of storing content of differing durations—a limited duration and a persistent duration.

### BRIEF DESCRIPTION OF THE DRAWINGS

These and other features, aspects and advantages of the present invention will become better understood with reference to the following description, appended claims, and accompanying drawings where

FIG. 1 illustrates a cross section of a combined CD and DVD embodiment consistent with the invention;

FIG. 2 illustrates a cross section of a combined CD and DVD embodiment consistent with the invention with both data layers on top substrate and a reactive dye or corrosion chemistry in bonding layer;

FIG. 3 illustrates a cross section of a combined CD and DVD embodiment consistent with the invention with a protective lacquer over the CD reflective layer before bonding;

FIG. 4 illustrates a cross section of a combined CD and DVD embodiment consistent with the invention without a CD lacquer layer before bonding;

FIG. 5 illustrates a cross section of a limited play DVD with a CD recordable layer embodiment consistent with the invention;

FIG. 6 illustrates a cross section of a DVD embodiment consistent with the invention with two standard DVD bonded back to back, wherein at least one layer is limited play

FIG. 7 illustrates a cross section of a DVD recordable the L0 layer with L1 prerecorded layer embodiment consistent with the invention, wherein the bonding layer includes a read limiting agent;

FIG. 8 illustrates a cross section of a DVD recordable on the L0 side with a limited play DVD on L1 side embodiment consistent with the invention;

FIG. 9 illustrates a cross section of a limited play DVD with a permanent play DVD read from the top side embodiment consistent with the invention;

FIG. 10 illustrates a cross section of a limited play DVD with a permanent play DVD recordable layer embodiment consistent with the invention;

FIG. 11 illustrates a cross section of a limited play HD-DVD dual layer top substrate bonded with a DVD embodiment consistent with the invention, wherein either or both the HD-DVD layer or the DVD layer are limited life layers;

FIG. 12 illustrates a cross section of a Blu-ray data layer(s) combined with DVD data and/or recordable layers embodiment consistent with the invention;

FIG. 13 illustrates a cross section of a Blu-ray data layer(s) combined with DVD data and/or recordable layers embodiment consistent with the invention;

FIG. 14 illustrates a cross section of a Blue-ray top data layer (dual layer shown) combined with HD-DVD data layer (dual layer shown) read from the bottom embodiment consistent with the invention; and

FIG. 15 illustrates a cross section of a DVD Recordable L0 layer with a L1 prerecorded layer embodiment consistent with the invention.

### DESCRIPTION

Reference will now be made in detail to embodiments of the present invention as illustrated in the accompanying drawings. The same reference numbers may be used throughout the drawings and the following description to refer to the same or like parts. The following description is presented to enable any person skilled in the art to make and use the inventive body of work. Descriptions of specific embodiments and applications are provided only as examples, and various modifications will be readily apparent to those skilled in the art. For example, although many of the examples are described in the context of certain data type combinations any single data type may be made limited play, it should be understood that embodiments of the present invention could be used to in any data type combinations even those combinations not expressly stated, or the like. Similarly, although for the sake of illustration many of the examples describe a read limiting agent and/or mechanism in the bonding layer, those of ordinary skill in the art will appreciate that the apparatus, devices and products of the present invention can be applied to any suitable to a read limiting agent anywhere in the optical medium. The general principles described herein may be applied to other embodiments and applications without departing from the spirit and scope of the invention. Thus, the present invention is to be accorded the widest scope, encompassing numerous alternatives, modifications, and equivalents consistent with the principles and features disclosed herein. For purpose of clarity, details related to technical material that is known in the fields related to the invention have not been described in detail so as not to unnecessarily obscure the present invention.

Overview

In one embodiment consistent with the invention a limited life CD, CD-ROM, and/or CD-R optical disc utilizing a corrosive agent and/or agent for degrading the integrity of a reflective layer and/or portion there of located in a layer and/or region adjacent to the reflective layer of the disc is described.

In another embodiment consistent with the invention a limited life CD, CD-ROM, and/or CD-R utilizing a dye in the optical path of the 780 nm laser is described. The optical disc employs two substrates bonded together with a dye adhesive while the data layer resides on top of the substrate stack at approximately 1.2 mm above the bottom surface of the layered disc.

In yet another embodiment consistent with the invention a limited play DVD combined with a CD data layer or recordable layer is described. In yet still a further embodiment a corrosive agent and/or agent for degrading the integrity of a reflective layer and/or portion thereof located adjacent to one or more reflective layers of the DVD and/or CD data layer is described.

In a further embodiment consistent with the invention a dye material is incorporated in the optical path of the reading laser.

In another embodiment consistent with the invention a permanent play and/or recordable layer survives after the limited play mechanism is activated and the limited play layer(s) has ceased to play.

In an embodiment consistent with the invention a limited play DVD including recordable and dual layer disc halves using a corrosive material and/or an agent for degrading the integrity of at least one reflective layer and/or portion thereof in a layer adjacent to any reflective layer within the optical disc is disclosed. In an overlapping embodiment a permanent play and/or recordable DVD layer survives after the limited play mechanism is activated and the limited play layer(s) has ceased to play.

In another embodiment consistent with the invention a limited play DVD including recordable and dual layer disc halves using a dye material to inhibit the ability of the reading laser to read a data layer within the optical disc is disclosed. In an overlapping embodiment a permanent play and/or recordable DVD layer survives after the limited play mechanism is activated and the limited play layer(s) has ceased to play.

In a further embodiment consistent with the invention an optical disc combining HD-DVD, HD-DVD-R/RW and/or DVD/DVD-/+R/RW data layers within one disc where any one or more of the data and/or recordable layers is limited play is disclosed. In an overlapping embodiment, the limited play mechanism is a corrosive agent that is adjacent to one or more reflective layer. In a further overlapping embodiment a permanent play and/or recordable DVD layer survives after the limited play mechanism is activated and the limited play layer(s) has ceased to play. In yet another overlapping embodiment the read limiting agent is a dye that inhibits the reading of at least one data layer. In an overlapping embodiment with the dye, a permanent play and/or recordable layer survives after the limited play mechanism is activated and the limited play layer(s) has ceased to play.

In another embodiment consistent with the invention an optical medium combining HD-DVD, HD-DVD-/+R/RW and CD, CD-ROM, CD-R, and/or CD-RW data layers within one disc where any one or more of the data and/or recordable layers is limited play is disclosed. The limited play mechanism is selected from a corrosive material, dye material and/or combinations thereof. If the limited play mechanism is a corrosive material it is located adjacent to at least one reflective layer. In an overlapping embodiment a permanent play and/or recordable layer survives after the limited play mechanism is activated and the limited play layer(s) has ceased to play.

In an embodiment consistent with the invention an optical medium combining Blu-ray and DVD data and/or recordable layers within one disc where any one or more of the data and/or recordable layers is limited play is disclosed. The limited play mechanism is selected from a corrosive material, dye material and/or combinations thereof. If the limited play mechanism is a corrosive material it is located adjacent to at least one reflective layer. In an overlapping embodiment a permanent play and/or recordable layer survives after the limited play mechanism is activated and the limited play layer(s) has ceased to play.

In another embodiment consistent with the invention an optical medium combining Blu-ray and HD-DVD data and/or recordable layers within one disc where any one or more of the data and/or recordable layers is limited play is disclosed. The limited play mechanism is selected from a corrosive material, dye material and/or combinations thereof. If the limited play mechanism is a corrosive material it is located adjacent to at least one reflective layer. In an overlapping embodiment a permanent play and/or recordable layer survives after the limited play mechanism is activated and the limited play layer(s) has ceased to play.

In one embodiment consistent with the invention a compact disc (hereafter “CD”) includes a mechanism, chemical, agent and/or process for limiting the period of time encoded information stored on the CD can be read and/or accessed. The mechanism, chemical, agent and/or process for limiting the access time can be applied to CDs that have the encoded information encoded during the manufacturing process (i.e., CD-Read Only Memory, hereafter “CD-ROM”) and/or encoded information encoded by recording directly onto the CD (i.e., CD-Recordable and/or CD-Rewritable and the like). Further, the mechanism, chemical, agent and/or process for limiting the access time is independent of the type and/or kind of data and/or information encoded on the CD (i.e., audio, video, data, software, images, text, games, combinations thereof, etc.). CD standards, put forth by industry groups such as ECMA International, describe the technical and manufacturing aspects of the various CD formats, i.e., CD-Audio, CD-ROM CD-Recordable, CD-Rewritable, CD-Interactive, CD-Video.

In yet another embodiment consistent with the invention an optical media that includes at least two different types of data structures and/or data formats and at least one mechanism, chemical, agent and/or process for limiting access to the data region of either type of data structure and/or data format, all the types of data structures and/or data formats contained on the optical media, and/or portions thereof is described. This embodiment includes, for example, combinations of at least two data structures and/or data formats selected from Read Only Memory (ROM), Write Once, Read Many (WORM), Interactive (I), Erasable (E), CD-ROM, CD-WORM, CD-I, DVI, CD-EMO, OD3, ODD, Video Disk, IVD, Blu-ray, HD-DVD, DVD, DVD-R, DVD-Video, DVD-RAM, DVD-Audio, DVD-RAM, DVD-RW, DVD+RW, DVD+R, DVD-Video, SACD, variants of the above, and/or any data structure and/or data format that is readable by an optical beam and/or optical reading device, including holographic and 3-D optical storage devices. In this embodiment, the at least two data structures and/or data formats may be accessed by the reading beam(s) through the same substrate layer and/or substrate side, i.e., without physically flipping the disc over; each through a unique substrate layer and/or substrate side, i.e., physically flipping the disc over to access the data of the other type; or a combination thereof. In an overlapping embodiment consistent with the invention at least one data structure and/or data format may be accessed by the reading beam(s) through the same substrate layer and/or substrate side, i.e., without physically flipping the disc over; each through a unique substrate layer and/or substrate side, i.e., physically flipping the disc over to access the data of the other type; or a combination thereof.

In still another embodiment consistent with the invention an optical media includes a mechanism for recording information and storing it on the optical media and a mechanism, chemical, agent and/or process for limiting the period of time the recorded information is accessible. The data format recorded is not limited to CD, DVD, High Definition, Blu-ray, 3-D and/or holographic data formats and includes any recordable data format.

The specification frequently makes reference to “substrates,” “dye material,” and “corrosive material.” For purposes of clarity, substrate is meant to include any structural member of an optical medium used for support and/or to receive a subsequent layer such as for example, a data layer, reflective layer, bonding layer, buffer layer, lacquer layer, and additional substrate layer(s). Dye material refers to any material that prevents the reading beam from reading at least a portion of any data region after a predetermined time. Corrosive material refers to any material that degrades the integrity of at least a portion of any reflective layer and thus prevents the reading beam from reading a portion of any data region after a predetermined time.

The following U.S. patents and patent applications are hereby incorporated by reference in their entirety. U.S. Pat. Nos. 6,641,886; 6,838,144; 6,511,728; 6,537,635; 6,839,316; 6,678,239; 6,011,772; 6,343,063; 6,434,109; 6,756,103; 6,917,579; and U.S. patent application Ser. Nos. 10/162,417; 10/016,263; 10/163,473; 10/163,855; 10/163,472; 10/651,627; 60/627,209; and 60/627,386.

These and other features and advantages of the present invention will be presented in more detail in the following detailed description and the accompanying figures which illustrate by way of example the principles of the invention.

Compact Disc

In one embodiment consistent with the invention a compact disc (hereafter “CD”) includes a mechanism, chemical, agent and/or process for limiting the period of time encoded information stored on the CD can be read and/or accessed. The mechanism, chemical, agent and/or process for limiting the access time can be applied to CDs that have the encoded information encoded during the manufacturing process (i.e., CD-Read Only Memory, hereafter “CD-ROM”) and/or encoded information encoded by recording directly onto the CD (i.e., CD-Recordable and/or CD-Rewritable and the like). Further, the mechanism, chemical, agent and/or process for limiting the access time is independent of the type and/or kind of data and/or information encoded on the CD (i.e., audio, video, data, software, images, etc.). CD standards, put forth by industry groups, such as ECMA and ISO, describe the technical and manufacturing aspects of the various CD formats, i.e., CD-Audio, CD-ROM CD-Recordable, CD-Rewritable, CD-Interactive, CD-Video.

The various CD formats generally adhere to a disc structure based on a 1.2 mm thick molded substrate with a data layer on the top surface coated with a reflective layer. The data layer is read from the bottom side of the substrate by a 720 nm. laser.

In one embodiment consistent with the invention a limited play optical CD can be constructed using a corrosive material layer adjacent to the reflective layer. The corrosive agent responds to a stimulus and/or triggering event, such as for example, exposure to oxygen, which causes the corrosive agent to react with the reflective layer such that the associated data layer, or a portion thereof, is no longer readable by the read laser of the reading device.

In another embodiment consistent with the invention a 1.2 mm thick optically transparent substrate is constructed with multiple layers, at least two, of molded substrates. Two 0.6 mm thick substrates are bonded together using a reactive dye material to form a 1.2 mm. thick substrate. However, it should be noted that two halves and/or substrates of equal thickness are not required, for example, one substrate could be 0.4 mm thick and the other 0.8 mm thick and variations thereof. Moreover, the total overall thickness of 1.2 mm is just to comply with the specifications set forth by ECMA, ISO, and the DVD Forum so that discs will play in a large percentage of the players currently in the homes of consumers. However, as the standards bodies change the specifications so too the embodiments consistent with the invention can be changed. This applies for CD, DVD, High Definition, Blu-ray, and other next generation optical media. The bottom substrate, or L0 substrate as it is referred to in a DVD construct, would be a blank disc with no data structures molded on either surface of the L0 substrate. The second substrate is molded with a CD data layer or recordable structures on the top surface. The surface is then coated with a reflective layer or recordable layers to complete the disc according to its format specifications and as specified by disc standards bodies such as, for example, ECMA and ISO. The reactive dye in the bonding layer, when exposed to a stimulus and/or triggering event, such as for example exposure to oxygen, will disable the ability of the laser to read or record data from the disc.

The above embodiments do not require that the limited play mechanism, i.e., corrosive agent and/or reactive dye, be an entire layer or be throughout a single layer and either can be present in limited regions of the media. For example, the limited play mechanism can be localized to a region and/or regions that prevent the entire encoded information stored on the media from being read by the reading beam. Alternatively, the regions with the localized mechanism will be the regions associated with the limited play mechanism.

CD/DVD Hybrid

Combining the functionality of a CD or DVD together on one disc has been recently accepted by the music industry with the release of a Dual Disc product. As this disc does not meet the original Philips Red Book specifications for disc thickness, it is unique in that it has received industry acceptance due to its compatibility with the majority of players in the market, while technically not meeting thickness specifications.

In an embodiment consistent with the invention limited play media constructs with modified disc thicknesses are disclosed. In this embodiment a thin CD is placed back to back with a thin DVD. The CD, DVD, portions of either and/or both, or both disc types include a limited play mechanism, such as for example, a dye in the optical path and/or corrosion of the reflective layer or portions thereof. As described above, the CD substrate can be, for example, an audio, ROM, recordable, or rewritable disc while the DVD side can be, for example, a DVD-5, an inverse DVD-5, DVD-9, DVD-Recordable, or DVD-Rewritable. These two substrates with associated data structures, recording layers, and appropriate reflective layers can be combined together in any combination.

In yet another embodiment consistent with the invention a CD data layer and a DVD data layer use two substrates bonded together and are read from one substrate side.

In still another embodiment consistent with the invention an optical medium includes encoded information with two separate life times, a limited life and an indefinite life. In this embodiment the medium is played and/or read, for both DVD and CD, from one substrate side. The reflective layers can be selected from metallic films, dielectric semi-reflective films, metallic semi-reflective films, dielectric films, and/or combinations thereof.

Metallic semi-reflective films have an effect on the reading of the 780 nm laser used to read the CD layer. Dielectric films can be made which are transparent at 780 nm and reflective at 650 nm. A combination of semi-reflective films may also be used to form a layered semi-reflective film. A mechanism for limited the time a reflective layer and/or semi-reflective layer can be read by a reading beam and/or for limiting the integrity of a reflective layer and/or semi-reflective layer with the inclusion of a dye, corrosive material and/or other reading limiting agent in the optical path and/or adjacent to a reflective layer and/or semi-reflective layer. For example, in one embodiment consistent with the invention wherein the CD data layer and DVD data layer are read from one substrate side a corrosive material eliminates the L0 semi-reflective layer and removes that reflected signal from that layer after a predefined period of time.

In another embodiment consistent with the invention, thicker, full reflective layers are not affected by the corrosive material. This can be accomplished either by the bulk properties of materials (thick film vs very thin) similar to the semi-reflective film or by changing the full reflective layer to a different material such as Au, or silver alloy that does not get impacted by the corrosion mechanism. Thus, providing an optically readable medium with two time scales of accessability.

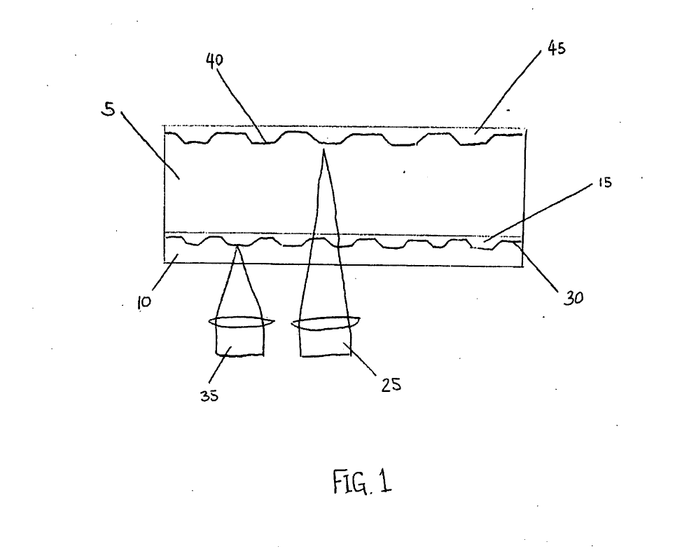

FIG. 1 illustrates an embodiment consistent with the invention that includes a limited play CD data layer 40, DVD data layer 30, or both. The bonding resin 15 is in the optical path of the CD read laser 25. With a reflective layer 30 on L0 10, the CD laser 25 is not blocked by this first reflective layer. The CD laser 25 then reads the L1 5 data through the bonding resin 15 that includes a reactive dye material that absorbs the read laser after a predetermined period of time. In this embodiment the CD data is of limited duration and/or limited accessability. The L1 layer 5 is caped with a protective layer 45. Alternatively, the semi-reflective 30 L0 layer 10 is bonded with a material that results in corrosion of the L0 10 reflective layer 30 after a predefined period of time. This configuration degrades the DVD reflective layer 10 and creates a limited play DVD layer because the reflectivity deteriorates to the point that the optical reading beam 35 is not reflected back in a sufficient manner to all it to be read. In this configuration the CD data layer 40 is permanent play.

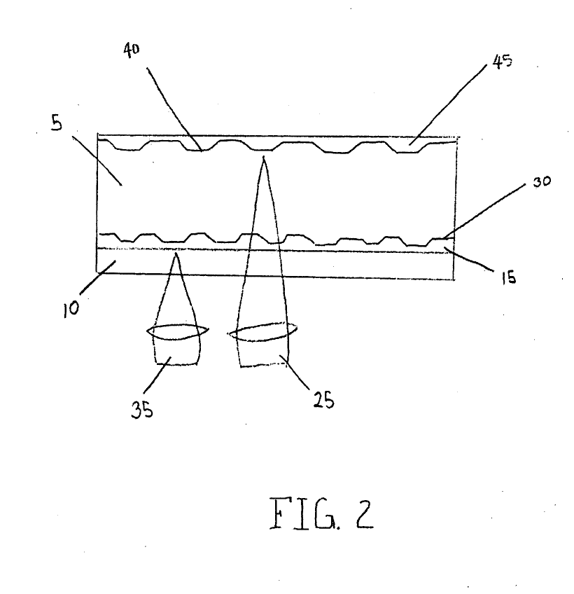

FIG. 2 illustrates an optical medium as in FIG. 1, however the DVD portion is made using an inverse DVD-5 as disclosed in U.S. patent application Ser. Nos. 10/163,473, 10/163,855, 10/163,472, 10/837,826, 10/163,821, 10/651,627 and U.S. Pat. No. 6,756,103, all hereafter incorporated by reference in their entirety. In this embodiment, the L1 disc 5 has CD data structures on the top side, and DVD data structures on the bottom of the same disc half 5. (i.e., data structures on both sides of the top disc half). This embodiment enables the use of bonding resins 15 based on either corrosive materials as in the examples above or dye materials as the bonding layer is located within the optical path of the reading beam(s). Both metallic and dielectric semi-reflective layers can be used. Metallic semi-reflective films do have an effect on the reading of the 780 nm laser used for the CD layer 40. In thinner films, the read signal is still acceptable. Dielectric films such as silicon, silicon oxides, or silicon nitrides can be used as the semi-reflective layer 30, which are transparent at 780 nm and reflective at 650 nm. Using dye materials, dielectric films do not need to be eroded with a corrosive material so that they can be optimized for their optical properties. This provides signals for the CD layer 40 that meet all specifications and provide a wider processing window.

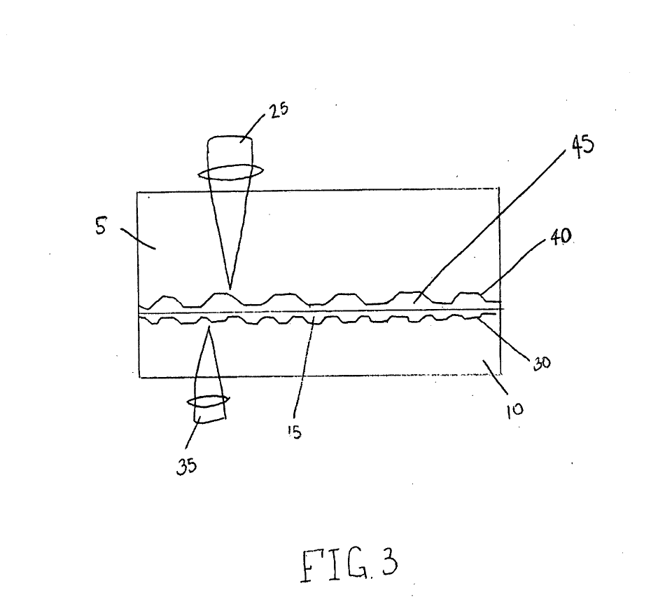

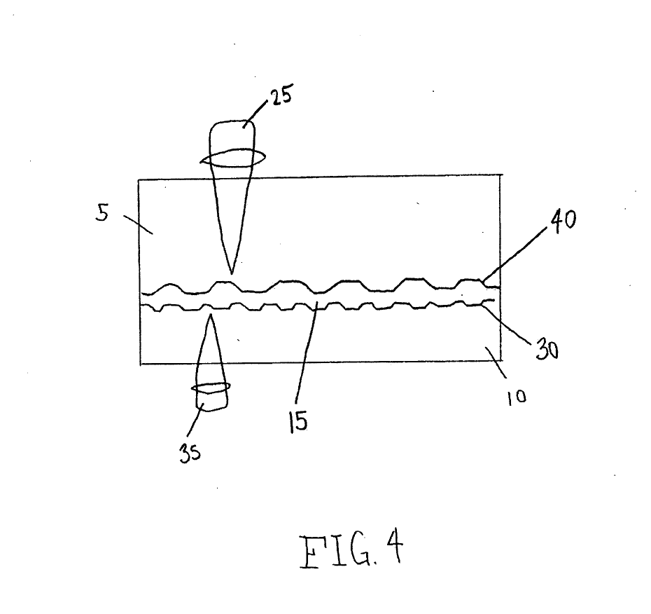

In another embodiment consistent with the invention an optical medium includes encoded information with two separate discs, bonded back to back. In this embodiment, disc thickness is kept approximately in the range of 1.5 mm or lower to keep the overall disc thickness within the ranges specified by ECMA and/or ISO. However, as specifications of ECMA and ISO change so to can the disc thickness and consistent with the invention. In this embodiment the two disc halves are manufactured below the lower disc specifications on disc thickness and as specified by the DVD Forum and ECMA. For example, a standard long playing DVD disc half is currently manufactured at a thickness of 0.6 mm and a CD substrate at 1.2 mm. Combining the two formats into a single disc without modification would create a disc thickness in excess of 1.8 mm when bonded together back to back. By reducing the two substrates to just below minimum thickness specifications, it is possible to achieve a disc thickness below 1.5 mm while still maintaining playability in an estimated 98% of players currently on the market. FIG. 3 illustrates a CD with protective lacquer 45 over the reflective layer 40 before bonding 15 to the DVD layer. FIG. 4 illustrates a CD disc and a DVD disc bonded together without the lacquer layer 45 as it is replaced by the bonding material 15. In this example, a CD disc and a DVD half bonded together without a lacquer layer 45, the limited play mechanism uses a corrosive material to erode the semi-reflective film.

DVD-9 Bonded to a CD

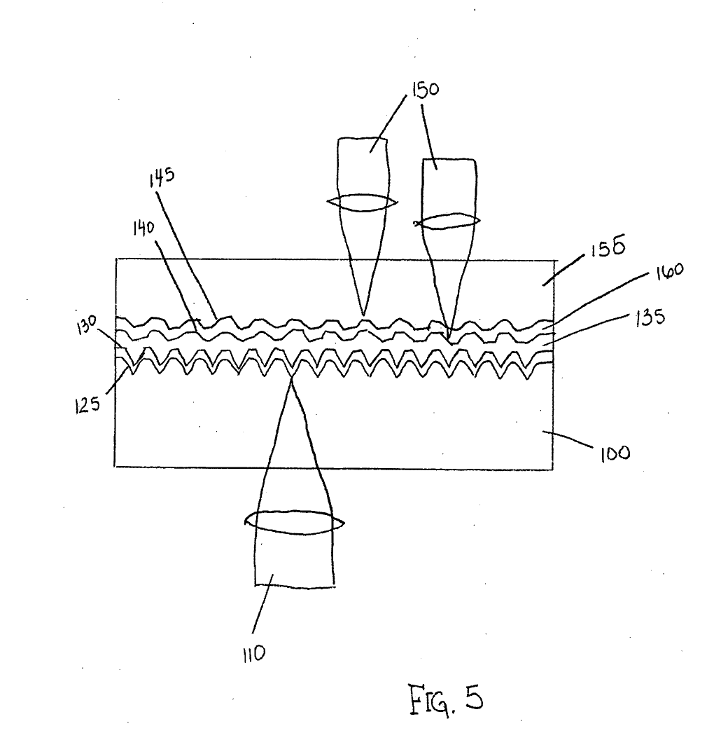

Using the peel technique of the L1 substrate to make a DVD-9 disc half, a limited play DVD-9 can be bonded back to back with a CD to make a further embodiment consistent with the invention of a limited play DVD combined with a permanent play CD format substrate as shown below in FIG. 5. This is similar to the DVD half bonded to the CD described earlier and shown in FIGS. 3 and 4. The L0 disc half 100 is molded thinner than ECMA, ISO, DVD Forum specifications to keep total disc thickness below 1.5 mm. Since the disc is flipped to be read from each side, the reflective layers are optimized for each side, CD and DVD. This DVD-9 limited play disc half is then bonded to either a permanent play CD or recordable CD, again molded with a thinner substrate. FIG. 5 depicts this construct with a recordable CD layer 125. FIG. 5 depicts CD data structures 125 on the L0 layer 100. The CD data structures are read by a reading beam 110 incident to the L0 layer 100. The CD data structures 125 in this illustration result from a recordable layer. Immediately adjacent to the recordable layer is a reflective layer 130. The CD half is bonded 135 to a DVD-9 half. The DVD-9 half in in the L1 layer 150. This naming is just a convention in this illustration since the disc has to be flip over to read the DVD-9 data. The DVD-9 half has two reflective layers 140 and 145, respectively. The DVD-9 data is read by an optical beam 155 of a different wavelength than that used to read the CD data. A read limiting material 160 is located between the two reflective layers 140 and 145. The embodiment shown in FIG. 5 represents a long playing CD-R with a limited life DVD.

DVD Formats

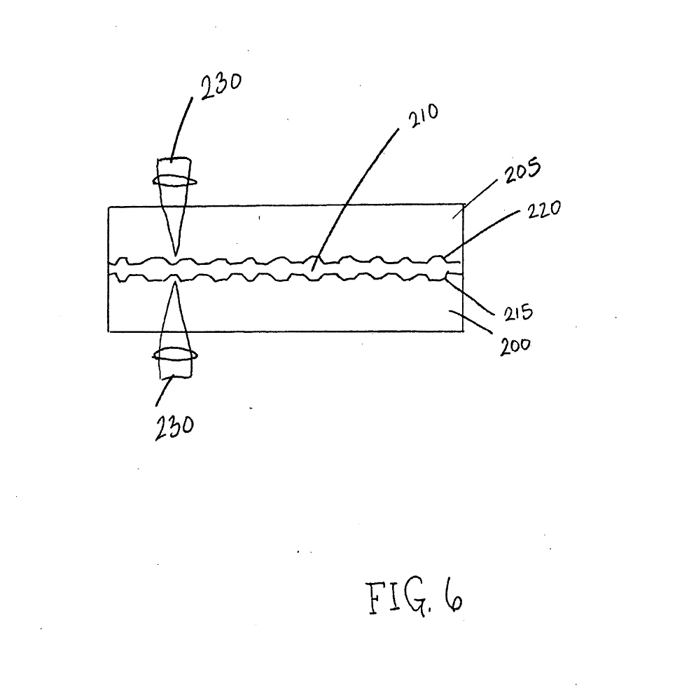

FIG. 6 illustrates an embodiment of an optical medium that contains encoded information with two separate life times. As shown in FIG. 6, the L0 200 encoded information is the limited life side. After a predetermined time the encoded information on this side becomes irreversibly in accessible. The L1 205 encoded information is the long life side. After the L0 200 encoded information is no longer accessible the L1 205 encoded information will remain accessible. The corrosion agent 210 eliminates the L0 200 silver reflective layer 215 and thus removes the reflected signal, created by the reading 230, beams from that layer. To prevent the L1 205 reflective layer 220 from being affected by the same mechanism, the reflective layer 220 can be made thicker or of an alternative reflective material can be substituted in this layer.

### EXAMPLE

DVD-10 discs were made using an L0 reflective layer which was varied in thickness and corresponding reflectivity. It was determined that a great majority of consumer players will play a DVD-5 disc half at much lower reflectivities than DVD specifications. To create a limited play optical media, the reflective film was reduced in reflectivity to that of an equivalent layer used in DVD-9 manufacturing of the L0 layer. This reflectivity ranges from 18 to 30%. Discs were also made at reflectivities increasing until the DVD specification (as defined by ECMA, ISO and DVD Forum) of 45% was reached. This reflective layer is susceptible to corrosion effects. By varying the thickness of the reflective layer, one can also effect the play time of the media. Playability was acceptable in our testing with a range of consumer players such as the Pioneer DV-563A, JVC XV-N50, and Panasonic DVD S-25.

When the L0 reflective layer was increased until DVD-5 specifications (as defined by ECMA, ISO, and DVD Form) were met with a minimum reflectivity of 45%, the L0 reflective layer can still be produced with significantly less thickness than the L1 layer. This allows the L1 to be made with the same material but still maintain its reflective properties for permanent play. As mentioned previously, the L1 layer can also be made with alternate reflective materials such as gold (Au) which would not react to degrade the reflectivity of the layer with the read limiting mechanism, rendering one side of the disc playable after one side has failed to play.

DVD-9 with One Recordable Layer

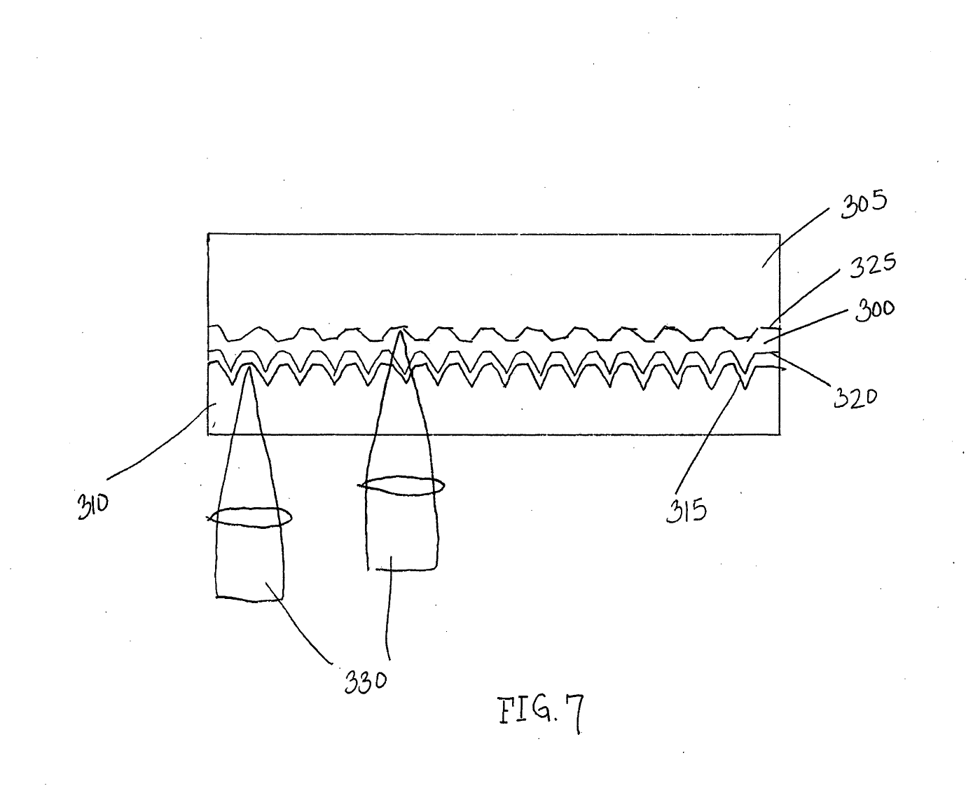

In another embodiment consistent with the present invention a limited play disc with a recordable layer is described. A read limiting agent 300 is integrated within a bonding adhesive, which is used to bond two substrates, 305 and 310 respectively, together. The L1 disc half 305 is bonded using an adhesive containing a read limiting agent 300 to a L0 substrate 310 with a recordable dye coated 315 on a grooved surface 320 as specified in recordable formats by the various standards bodies. This construct shown in FIG. 7 provides a disc with a limited play L1 data layer 305 and a recordable L0 layer 310 that will play after the L1 data 325 has become unreadable by the reading beam 330. Using authoring techniques the entire L0 layer 310 or a part of it can also be defined as a limited play area. Further, the limited mechanism, does not have to be an entire layer or through out the disc and instead may be localized to a select region(s), such localization may, depending on the configuration, prevent access to all the data on a particular layer or selection regions only. The L0 layer 310 could then still be recordable. The disc is authored so that when inserted into a player, the L1 layer 305 would be recognized as having been recorded and the L0 layer 310 available for recording.

DVD-R/DVD-5 Limited Play Disc

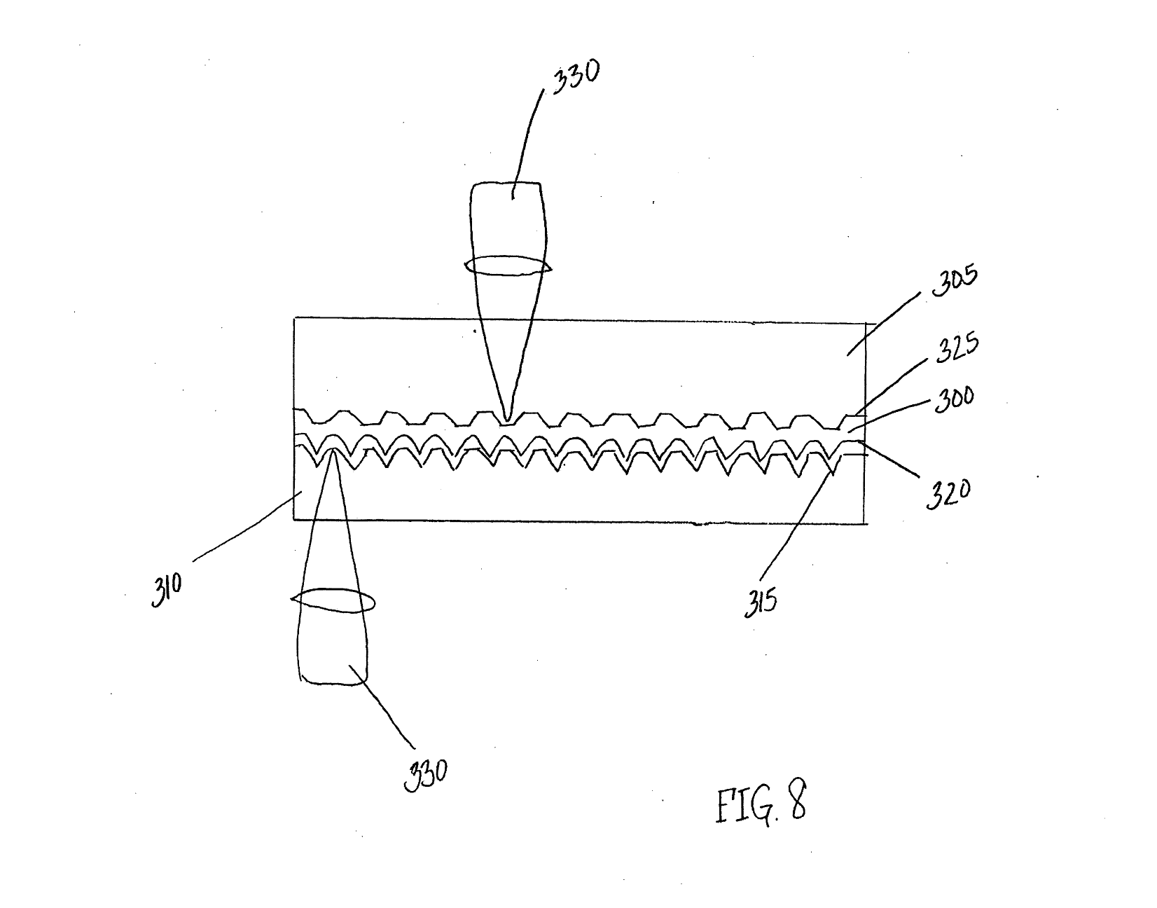

In yet another embodiment consistent with the invention a disc is constructed using a DVD-R 310 bonded to a DVD-5 305. One side plays the DVD-5 content, for example, movie or video content. Once flipped over a single layer DVD-R is available for recording data. The bonding resin 300 employs a material that corrodes the reflective 325 DVD-5 film without attacking the reflective layer 320 of the recordable side. This embodiment is shown in FIG. 8.

DVD 14/18 Constructs with DVD 9 Read from One Side and DVD-5/9 or Recordable DVD 5/Dual Layer on the Flip Side.

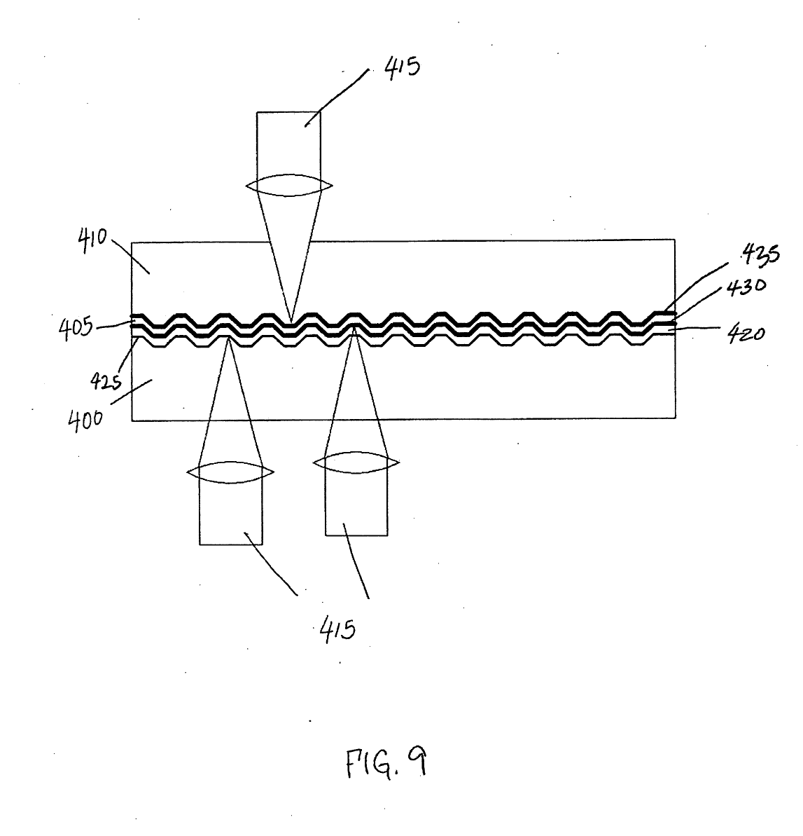

Using existing dye technology, and as disclosed in the above referenced U.S. patents and applications, DVD 14 discs can be manufactured which combine a limited play DVD-9 with a permanent play DVD-5 layer as shown in FIG. 9. Once the DVD-9 is manufactured, the top substrate is mechanically peeled away as in a standard DVD-14 process, and a new top substrate bonded to the disc. This new substrate can be either a permanent play DVD-5, a second permanent play peeled DVD-9 half, limited play peeled DVD-9 half, or a recordable DVD-5 half or dual layer recordable DVD disc half. In this way several combinations of disc halves can be combined using recordable, permanent play, or limited play disc halves. For example, FIG. 9 shows a limited play DVD-9 in the L0 position 400 bonded 405 to a permanent play DVD-5 in the L1 position 410 that is read by flipping the disc over. Both side use a reading beam 415 of the same optical wavelength to read the encoded data. A read inhibiting material 420 is located between the two reflective layers 425 and 430, respectively, of the DVD-9 side. The reflective layer 435 of the DVD-5 side reflects the optical reading beam 415 through the L1 410 side to a reading device.

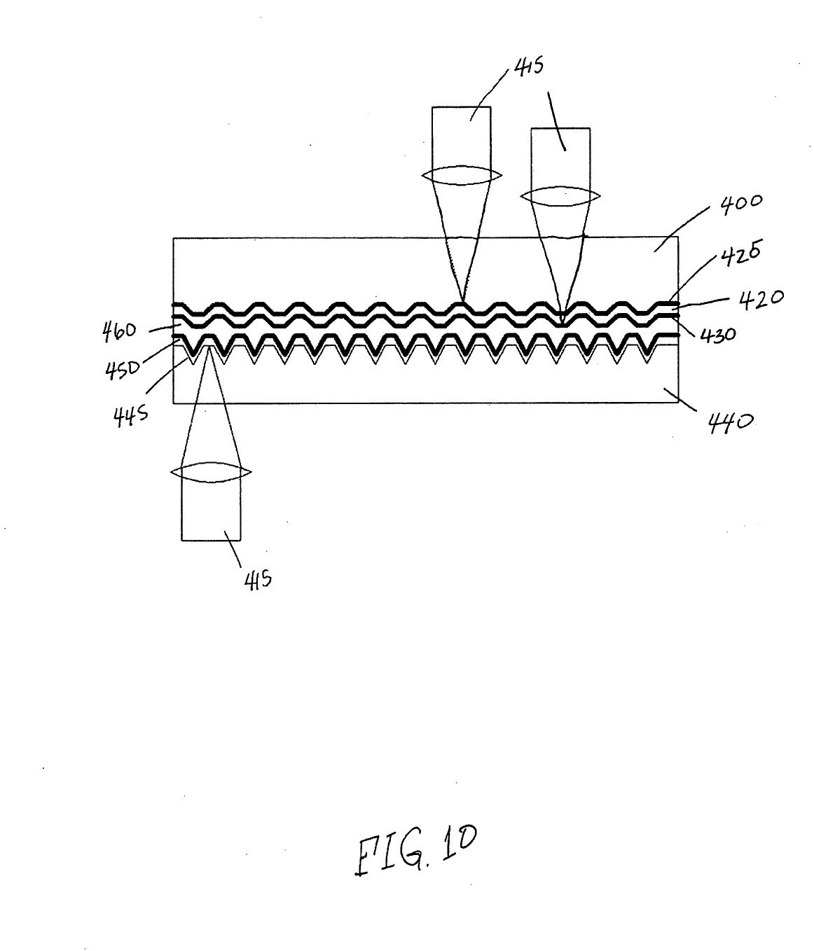

FIG. 10 shows a DVD-9 limited play disc half in the L1 position 400 bonded to a single layer recordable 445 DVD disc half in the L0 position 440 that must be recorded by flipping the disc over. The reflective layer 450 of the L0 position is behind the recordable layer 445 with respect to the optical path of the reading beam 415. In this way disc capacities can be increased, recordable layers combined with limited play data regions, and permanent play areas extended to entire layers. This provides significant flexibility to address many applications of permanent play, limited play, and recordable applications.

HD-DVD Formats

It is clear from the discussion and depiction of various constructs above that many different forms or combinations of optical disc formats can be combined with limited play technology. This also applies to bringing together various high density disc formats with conventional DVD formats, or even combining both proposed high density formats, HD-DVD and Blu-ray, on a single disc. The following embodiments of the invention combine limited play and/or conventional HD-DVD and/or Blu-ray data layers with limited play and/or conventional DVD layers. The Blu-ray and HD-DVD limited play constructs have been discussed in the above referenced U.S. patent applications, which are incorporated reference herein in its entirety. In a further embodiment, all data layers could be limited play or conventional permanent data layers. These constructs provide a large matrix of possibilities combining formats with and without limited play access to either all or selected sections of the recorded data on the data layer.

Limited play optical media can be produced incorporating reactive materials in the disc substrate, bonding layer, or coatings within the structure of the disc or layered on the surface of the disc. A long playing Digital Versatile Disc (DVD) is normally constructed with the bonding of two 0.6 mm substrates. The current proposed specifications for Blu-ray and HD-DVD discs differ in their data layer location and disc construction. Blu-ray and HD-DVD data layers can be combined in one disc using reactive materials that can be incorporated into the construct of the disc which can eliminate the playability of all or part of the stored data on the disc. Because these discs are still constructed from layered substrates, novel constructs can be created which were not anticipated by those who developed the high definition video disc specifications for both Blue-ray and HD-DVD. In particular, the combination of both formats into a single disc with and without limited play data layers is envisioned. Additionally, selected layers can also include recordable functionality.

HD-DVD and DVD 5/9/Recordable Data Layers

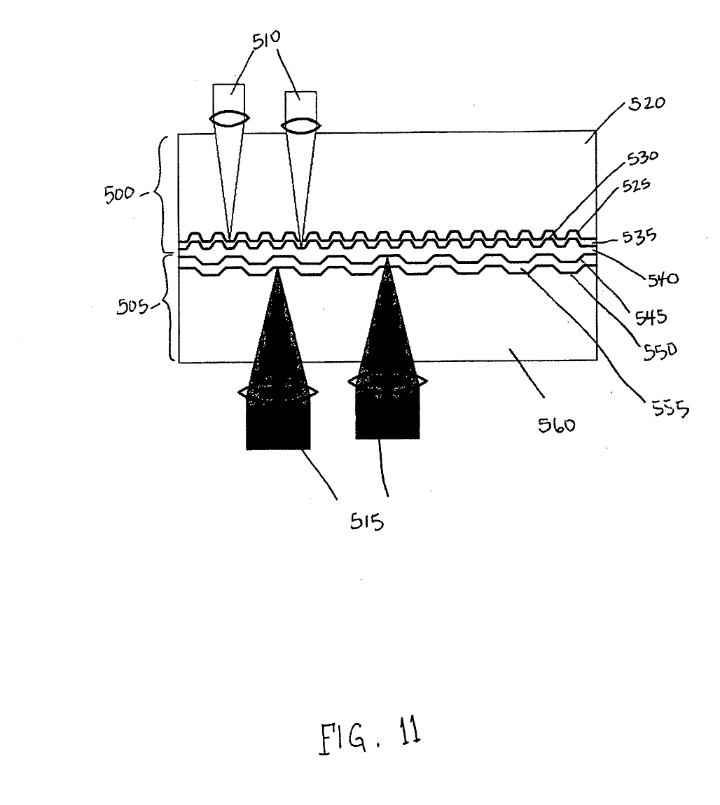

In the HD-DVD specification set forth by the DVD Forum, the product essentially uses two 0.6 mm substrates bonded together much in the same way as standard DVD. In an embodiment consistent with the invention, standard DVD data layers, both permanent and limited play are combined together with HD-DVD data layers, both permanent and limited play. For single layer HD-DVD and single layer DVD combinations, the two disc substrates are simply bonded together giving a DVD 5 or single layer DVD-R played or recorded from one side and a single layer HD-DVD or recordable HD-DVD played or recorded from the other. Either substrate could also have a second data layer added through standard DVD-14/18 bonding stripping techniques, or recordable layers added through standard dual layer recordable manufacturing processes. FIG. 11 illustrates two dual layer substrates bonded together to form an HD-DVD dual layer disc 500 combined with a DVD-9 505. FIG. 11 illustrates an HD-DVD dual layer disc 500 half highlighting the substrate 520, in the L1 position, two reflective layers, 530 and 525 respectively, and an adhesive layer 535. The adhesive layer 535 may further contain a read limiting material depending on whether the HD-DVD data is the side selected to be of limited duration. The DVD-9 half highlights the substrate 560, in the L0 position, the two reflective layers 545 and 550 respectively, and a bonding layer 555 between the two reflective layers 545 and 550. The bonding layer 555 may further include a read inhibiting material depending on whether DVD-9 data has been selected to be of a limited duration. The two disc halves are connect by a bonding layer 540. The bonding layer 540 may further include a read limiting agent. Any of the data layers can be made limited play through the addition of reactive materials into the bonding resin, reflective layers, and/or substrates of the disc. The limited play capability could limit access to a part of any data layer or all of the data stored on the disc.

Blu-Ray and DVD 9/5/Recordable Hybrid Disc

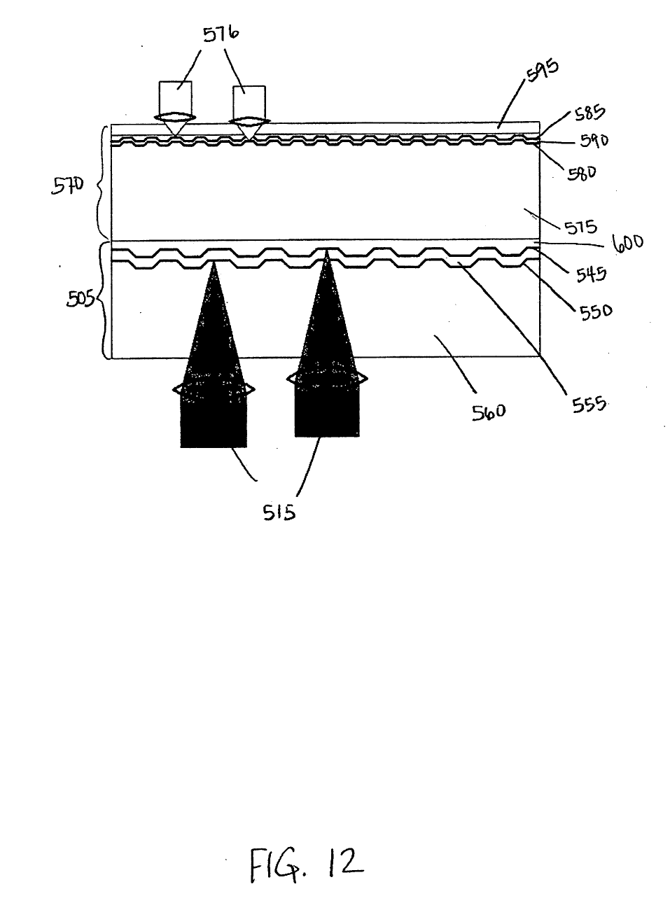

As cited above, the Blue-ray disc is constructed with a 1.1 mm substrate that is not in the optical path. Therefore it is possible to create that substrate using two substrate layers bonded together. Instead of molding substrates with HD-DVD layers, it is also possible to use standard DVD data layers including DVD-5, DVD-9, and single or dual layer recordable data layers within the 1.1 mm substrate of the Blu-ray disc an example of which is shown in FIG. 12. This embodiment combines limited play capability to a part or all of the data stored and/or recorded onto the disc or any of its data layers.

FIG. 12 illustrates a DVD-9 disc half 505 bonded 600 to a Blu-ray disc half 570. The features shown in FIG. 12 for the DVD-9 half 505 are identical to those shown in, and already discussed in FIG. 11. The DVD-9 disc half 505 is bonded 600 to the Blu-ray disc half 570. The Blu-ray data features and reflective layers, 585 and 580 respectively, are covered by a hard protective top coat 595. The two reflective layers, 585 and 580, are bonded together via a bonding layer 590. The data structures of the Blu-ray disc half 570 are read by an optical beam 576 with a wavelength different than the wavelength of optical beam 515. The read inhibiting material and/or mechanism can be placed in any of the bonding layers and/or adjacent to any of the reflective layers depending on which disc half is designed to be of a limited duration.

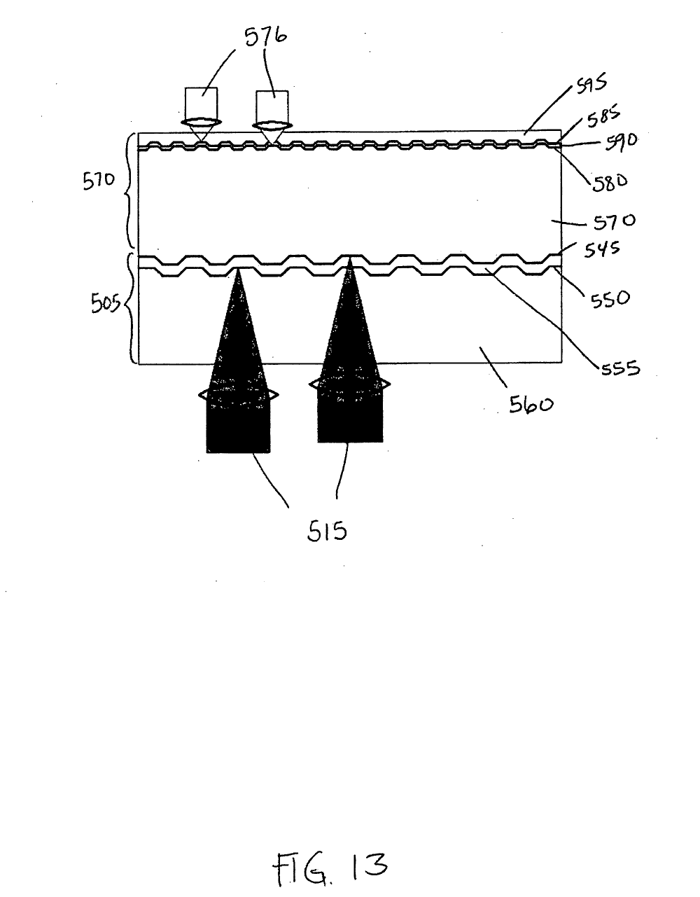

To achieve a dual layer DVD-9 505 using the above construct, a mold, bond, and strip process is typically used to form the second layer as in DVD-14/18 manufacturing processes. This could be eliminated if data layers were molded on both sides of the top substrate as shown below in FIG. 13. The read inhibiting material and/or mechanism can be placed in any of the bonding layers and/or adjacent to any of the reflective layers depending on which disc half is designed to be of a limited duration.

Hybrid HD=DVD and Blue-Ray Disc

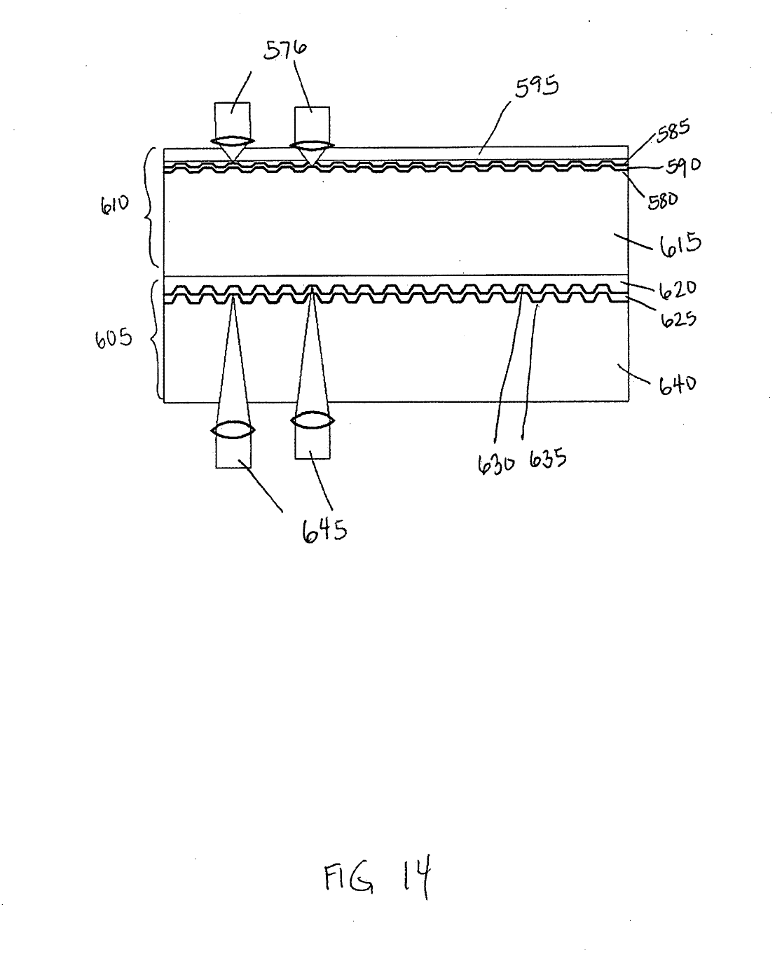

In another embodiment consistent with the invention both high definition optical disc formats (i.e., HD-DVD and Blu-ray) are combined into one disc as shown in FIG. 14. A Blue-ray substrate 615 is 1.1 mm thick and is not in the optical path of the laser. The data layer is on the top surface and bonded to a cover layer 595 through a variety of techniques including a spincoated layer, and/or bonding a thin 0.1 mm cover layer, and/or bonding/adhering a film layer to the disc to form the cover layer. Since the 1.1 mm substrate 615 is not in the optical path of a Blu-ray reading beam 576, that substrate 615 could be two layers bonded together as in DVD or HD-DVD manufacturing. The first layer would be 0.6 mm thick while the second would be 0.5 mm. The bonding layer could be a nominal 55 microns thick for DVD or thinner for the HD-DVD bonding layer. The second disc substrate 640 thickness would be adjusted accordingly depending on the bonding layer thickness. When bonded the total substrate thickness would meet the 1.1 mm Blu-ray substrate specification.

FIG. 14 above illustrates the hybrid construct of a Blu-ray disc combined with an HD-DVD optical disc. This is a unique and novel construction combining data layers that meet the specifications of two different proposed formats within a single optical disc. By using normal bonding and spincoating resins and/or other cover layer constructs for each format, both data layers would be permanent play data layers. The incorporation of reactive materials and/or limited play mechanisms within the bonding layers, and/or cover layer, and or/disc substrate, and/or reflective layers adds limited play capability to part of or entire data layers. In addition, we envision the combination of limited play characteristics, permanent play characteristics, and/or recordable layers within the construct of a single disc containing Blu-ray and HD-DVD data layers. FIG. 14 illustrates a Blu-ray disc half 610 and a HD-DVD disc half 605 bonded together via a bonding layer 620. The dimensions of both substrates 615 and 640 can be adjusted such that the combined disc halves meet playability standards for dimensional constraints that high definition players and/or reader may place on the discs. The Blu-ray disc half 610 and in the L1 position in the illustration of FIG. 14 and its features have already been discussed with FIG. 13. The HD-DVD disc half 605 as shown in FIG. 14 highlights the substrate 640 and the two reflective layers, 630 and 635, thus making the illustration shown in FIG. 14 a dual layer HD-DVD. A bonding layer 625 exists between the two reflective layer 630 and 635. The HD-DVD disc half is read by an optical reading beam 645. Upon observing FIG. 14 one will likely note the similarities between the hybrid Blu-ray and DVD-9 previously discussed in FIG. 13.

Recordable Limited Life Optical Media

In applications of on-demand recording of digital data including but not limited to audio or video such as music or movies, it may be desirable to be able to record information onto an optical disc that offers limited play capability for all or part of the recorded information. This can also be combined with a pre-recorded area or data layer within the disc structure.

In yet another embodiment consistent with the invention a optical medium is disclosed that can be used at point of distribution to selectively record data, including for example but not limited to software, songs, albums, music videos, feature films, or video segments that the customer desires to purchase. The method of distribution and recording could be a customer service station at a retail location with the associated recording device and appropriate packaging system or a fully integrated kiosk that is used directly by the consumer to automate the process and transaction.

An optical disc product to meet these use requirements has been designed combining a recordable data layer and a limited life mechanism. This basic construct can be combined with any of the preceding embodiment, including a pre-recorded second layer in a limited play DVD-9 format. The use of a second recordable layer is also possible.

In one embodiment consistent with the invention the disc construct follows the standard DVD-9 configuration of a bottom L0 disc half and/or substrate bonded to a top L1 disc half and/or substrate. This grooved substrate is then coated with a DVD recordable dye and metallized with a semi-reflective film to create the recordable L0 data layer within a dual layer DVD-9 construct. A read limiting dye is integrated within the adhesive used to bond the L0 and L1 substrates. The L1 substrate is molded as a pre-recorded data layer as is typical in a DVD-9 L1 data layer and metallized with a full reflective layer. Optionally, a second recordable layer may be used in a dual layer recordable construct. In either product configuration, the read limiting dye in the bonding layer limits access to the entire or selected areas of the second data layer after a predetermined period of time, limiting access to all or parts of the data stored on the optical disc. Interactions between the reflective layers and the reactive bonding layer can be prevented with a buffer layer applied to the reflective layer prior to bonding.

The disc is authored so that when inserted into a player, the L1 would be recognized as having been recorded and the L0 available for recording. The pre-recorded L1 data layer offers the ability to place data on the L1 that can serve as a check region or provide software for use in the player, kiosk, or recorder application. The use of check regions within the data structure of the disc can be employed to enhance the capability of a recordable limited play product, defining the limited play areas and providing access to selected parts of the recorded and pre-recorded information. The L0 layer may also have pre-recorded data in the recordable data area that contains information for the player, recording drive, or kiosk station to use as a check disc region, application information, or product configuration information.

The use of partially dispensing the reactive adhesive within the bonding layer may also be utilized to block the ability of the read laser to read limited areas of the recordable and/or pre-recorded data layers. In this way, the media can be configured to selectively allow limited play features to all of, or portions of, the data pre-recorded and/or recorded within the disc.

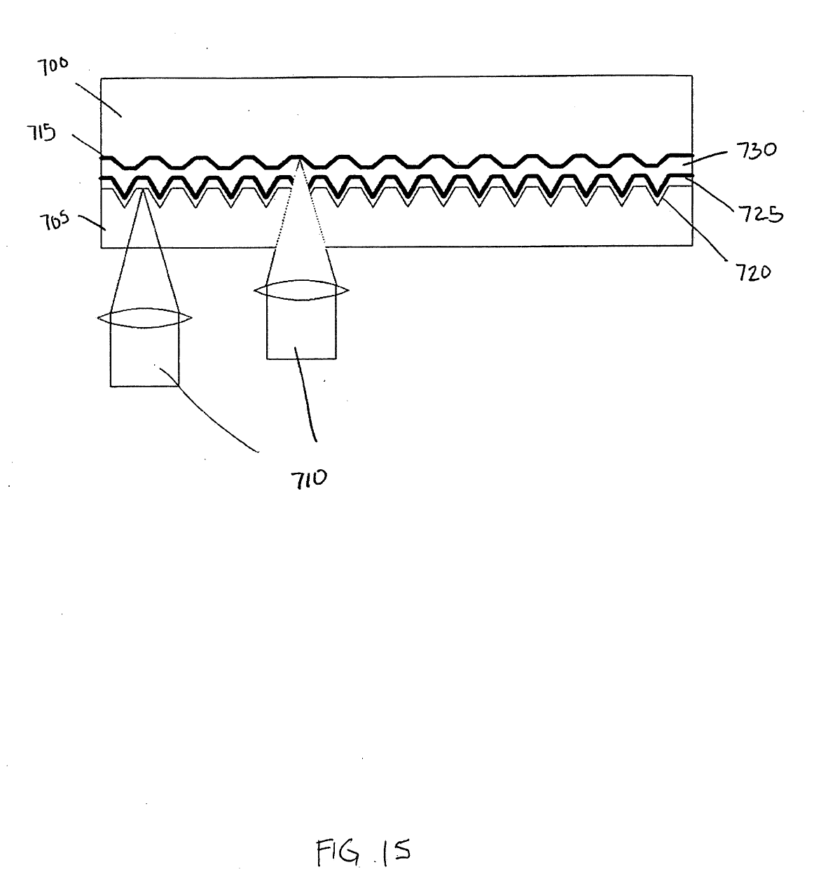

FIG. 15 illustrates one of the myriad of applications enabled by the invention. One use of optical media with a limited life occurs in the context of movie rentals. Because any content on a limited life optical medium can only be viewed within a specified time window content is never owned but instead checked out. Thus, enabling a consumer to rent content without the need to return the content. This results in a substantial costs savings with respect to an individual's time and fuel and/or postal costs associated with returning the content. However, some consumers may consider it wasteful to discard the optical media once the content has expired. Once way to eliminate the need to discard the expired optical media is to provide a functioning product once the content has expired and/or to allow some content to persist after the other content has expired. FIG. 15 illustrates a DVD configured in a modified DVD-9 format. The DVD is configured to have content which is recorded to have a limited life while providing a usable product once the recorded content has expired. The usable persistent product being a recordable data layer. Thus, the consumer can consume the limited life content, such as a movie, and once that content has expired the disc can be used to record the consumer's own content and/or data files that will persist. FIG. 17 highlights a few structural features of such an application and embodiment. The L0 layer 705 contains a recordable layer 720 and its associated reflective layer 725. A bonding layer 730 separates the recordable layer 720 and its associated reflective layer 725 from the second reflective layer 715, residing in the L1 layer 700. It is this second reflective layer 715 and its encoded data features that is of a limited duration. The bonding layer 730 contains a read inhibiting material such that the content recorded and associated with the second reflective layer 715 will expired after a predetermined time period and will no longer be readable by the optical reading beam 710. However, the recordable layer 720 will persist after the content associated with the second reflective layer 715 expires and remain available to the consumer and/or end user.

While numerous embodiments, including the preferred embodiments, of the invention have been illustrated and described, it will be appreciated that various changes can be made therein without departing from the spirit and scope of the invention.

What is claimed is:

1. An optically readable medium comprising:
a first substrate, said first substrate including features corresponding to a first information signal and optically readable by an optical beam of a first predetermined frequency;
a first reflective layer conformationally disposed on said first substrate;
a read inhibiting layer disposed on said first reflective layer;
a second reflective layer disposed on said read inhibiting layer;
a second substrate, said second substrate including features corresponding to a second information signal and optically readable by an optical beam of a second predetermined frequency;
wherein said second reflective layer conformationally disposed on said second substrate.

2. The optically readable medium of claim 1, wherein said read inhibiting layer inhibits reading of the first information signal within a predetermined period of time.

3. The optically readable medium of claim 2, wherein said read inhibiting layer destroys at least a portion of the first reflective layer within said predetermined period of time.

4. The optically readable medium of claim 2, wherein said read inhibiting layer absorbs at least a portion of said optical beam of the first predetermined frequency within the predetermined period of time.

5. The optically readable medium of claim 1, wherein said read inhibiting layer inhibits reading of the second information signal within a predetermined period of time.

6. The optically readable medium of claim 5, wherein said read inhibiting layer destroys at least a portion of the second reflective layer within said predetermined period of time.

7. The optically readable medium of claim 5, wherein said read inhibiting layer absorbs at least a portion of said optical beam of the second predetermined frequency within the predetermined period of time.

8. The optically readable medium of claim 1, further comprising a recordable layer disposed between said first substrate layer and said first reflective layer, wherein said recordable layer is optically deformable into features producing an information signal that is readable by the optical beam of the first predetermined frequency.

9. The optically readable medium of claim 1, further comprising a bonding layer disposed between said first reflective layer and said read inhibiting layer.

10. The optically readable medium of claim 9, further comprising a third reflective layer disposed between said bonding layer and said read inhibiting layer.

11. The optically readable medium of claim 10, wherein said third reflective layer conformationally disposed to be readable by the optical beam of the second predetermined frequency.

12. The optically readable medium of claim 1, further comprising:
a third reflective layer disposed on said read inhibiting layer;
a bonding layer disposed between said third reflective layer and said second reflective layer; and
a second bonding layer disposed between a fourth reflective layer and the second reflective layer.

13. The optically readable medium of claim 12, wherein the optical beam of the first predetermined frequency and the optical beam of the second predetermined frequency read the first information signal and the second information signal by passing through the first substrate.

14. The optically readable medium of claim 12, wherein the optical beam of the first predetermined frequency reads the first information signal by passing through the first substrate and the optical beam of the second predetermined frequency reads the second information signal by passing through the second substrate.

15. The optically readable medium of claim 12, wherein the second bonding layer includes a second read inhibiting layer.

16. An optically readable medium comprising:
a first optically readable medium comprising a substrate, data encoded information, a read inhibiting agent, and a reflective layer formed in this order and bonded to a second optically readable medium comprising a substrate, data encoded information, and a reflective layer formed in this order;
wherein the data encoded information of the first optically readable medium persists for a predetermined and limited duration of time;
wherein the data encoded information of the second optically readable medium persists indefinitely.

17. The optically readable medium of claim 16, wherein data encoded information of the first optically readable medium and the data encoded information of the second optically readable medium are each selected from one of the following formats Compact Disc, CD-ROM, CD-WORM, CD-Interactive, DVI, CD-Erasable Magneto Optic, Optical Digital Data Disc, ODD, Video Disk, Interactive Video Disc, Blu-ray, High Definition-DVD, DVD, DVD-R, DVD-Video, DVD-RAM, DVD-Audio, DVD-RAM, DVD-RW, DVD+RW, DVD+R, DVD-Video, Super Audio CD, Holographic Versatile Disk, CD-R, CD-RW, CD-Video, Enhanced Versatile Disc, Digital Versatile Disc Recordable, Digital Multilayer Disc, Blu-ray recordable, and combinations thereof.

18. A dual format optically readable medium comprising:
a first substrate comprising data encoded information, said data encoded information optically readable by an optical beam of a first predetermined wavelength;
a second substrate comprising data encoded information, said data encoded information optically readable by an optical beam of a second predetermined wavelength;
wherein said first substrate and said second substrate are conjoined so as to allow reading of the data encoded information;
wherein at least one of said first substrate and said second substrate includes a read inhibiting material that prohibits reading of the data encoded information on the first substrate, second substrate, or both substrates after a predetermined period of time.

19. The dual format optically readable medium of claim 18, wherein the data encoded information of said first substrate is selected from one of the following formats: Compact Disc, CD-ROM, CD-WORM, CD-Interactive, DVI, CD-Erasable Magneto Optic, Optical Digital Data Disc, ODD, Video Disk, Interactive Video Disc, Blu-ray, High Definition-DVD, Digital Versatile Disc, DVD-R, DVD-Video, DVD-RAM, DVD-Audio, DVD-RAM, DVD-RW, DVD+RW, DVD+R, DVD-Video, Super Audio CD, Holographic Versatile Disk, CD-R, CD-RW, CD-Video, Enhanced Versatile Disc, Digital Versatile Disc Recordable, Digital Multilayer Disc, and Blu-ray recordable.

20. The dual format optically readable medium of claim 18, wherein the data encoded information of said second substrate is selected from one of the following formats: Compact Disc, CD-ROM, CD-WORM, CD-Interactive, DVI, CD-Erasable Magneto Optic, Optical Digital Data Disc, ODD, Video Disk, Interactive Video Disc, Blu-ray, High Definition-DVD, DVD, DVD-R, DVD-Video, DVD-RAM, DVD-Audio, DVD-RAM, DVD-RW, DVD+RW, DVD+R, DVD-Video, Super Audio CD, Holographic Versatile Disk, CD-R, CD-RW, CD-Video, Enhanced Versatile Disc, Digital Versatile Disc Recordable, Digital Multilayer Disc, and Blu-ray recordable.
